(19) United States
(12) Patent Application Publication
(10) Pub. No.: US 2009/0037256 A1
(43) Pub. Date: Feb. 5, 2009

(54) System for Transmitting and Managing Multimedia Content in Interactive Mode

(75) Inventors: Giorgio Rivetti, Pecetto Torinese (IT); Giovanni Malnati, Torino (IT); Andrea Carlevato, Torino (IT)

Correspondence Address: MERCHANT & GOULD PC, P.O. BOX 2903, MINNEAPOLIS, MN, 55402-0903, US

(73) Assignee: Giorgio Rivetti, Pecetto Torinese (IT)

(21) Appl. No.: 12/158,247

(22) PCT Filed: Nov. 24, 2006
(86) PCT No.: PCT/EP2006/011292

§ 371 Date: Aug. 1, 2008

(30) Foreign Application Priority Data
Dec. 23, 2005 (IT) TO2005A000901

(51) Int. Cl. G06Q 30/00; G06Q 10/00

(52) U.S. Cl. 705/10

(57) ABSTRACT

Abstract A system for transmitting and managing multimedia content in interactive mode, includes a series of advertising installations (11), to which are sent respective items of multimedia content (22) relating to a determined advertisement (12). The system distributes additional information content, which varies in accordance with the advertisement (12) and which is associated with the subject of the advertising communication on display, by transmitting multimedia files (18), in wireless mode, which are sent to users (14) who are equipped with a mobile terminal (15), such as a cellular telephone. The advertiser (13) can thus measure audience by analysing and counting the wireless connections carried out and the interactions which are activated by the user (14) with the web site (16) and/or the advertiser's call center (26).

The present invention refers, in general, to a system for transmitting and managing multimedia content in interactive mode.

More in particular, the invention relates to a system for transmitting and managing multimedia content of the advertising kind, which uses a service for transmitting multimedia content by exploiting a wireless data connection, based, for example, on Bluetooth technology and/or DVB-H standards and/or WI-FI, etc.

The system enables the association of multimedia content with an advertisement, affixed in an installation and/or attached to the interior or exterior of a means of transport, so that it is possible to measure the relative audience.

The advertiser client, who wishes to carry out an advertising campaign, uses the outdoor advertising installations and/or the means of transport, in particular of the public kind, (when the advertisement is attached to the interior or the exterior of the means of transport), in order to convey the multimedia content in wireless mode to the end users of such content.

Users must have a cellular telephone or other mobile receiving device and the audience is measured by means of analysing and counting the wireless connections carried out and the interactions which are activated by the user with the advertiser client. There are currently well known systems for supplying information services and/or multimedia content in a display context, by means of wireless networks.

In particular, systems for supplying information and/or multimedia content pertaining to an item of data by means of Bluetooth functions are well known. Such systems enable a user, who is in or near the immediate vicinity of a Bluetooth area, to download to his/her cellular telephone, equipped with a Bluetooth device, the multimedia content which pertains to the data in question, which is also transmitted by means of a Bluetooth transmitter and inserted in a database, which can supply determined content within determined pre-selectable areas.

In practice, Bluetooth cellular telephones receive an identity code from a determined item, which is suitable for being transferred, in turn, by means of the Bluetooth network, to a server, which sends the pertinent content again via the Bluetooth network.

In addition, each identity code of a determined item which is present within the Bluetooth area may be univocally linked to a determined item and the mobile terminal, once it has received the identity code, can connect to a determined server in order to use the multimedia information which is relative to the item. There are other well known methods for controlling transmission and reception of data on the Bluetooth network, which permits the user to select and request the data which interests him/her, among that which is made available by a given data application, once it has been downloaded to the mobile terminal.

The traditional kinds of alternatives which have so far been described provide, as has been seen, for a univocal exchange between the identity code and the multimedia content.

So far, however, there is no alternative solution available which provides for a relationship in which different identity codes correspond to the same content, in such a way that, in the first place, different Bluetooth transmitters (BTT), with different identifications and located in different Bluetooth information areas (BTIA), relate to the same information content on a server, and, furthermore, any mobile terminal whatsoever which is to be found in one of the various different Bluetooth areas (BTIA) can always download the same content.

In such a case, it would be possible to obtain a relationship between the Bluetooth transmitter (BTT) and the server without having to establish a relationship between the location and the transmitter and the transfer of information could take place directly from the Bluetooth transmitter to the user without the use of codes and/or networks operated by telephone companies.

In addition, such a system could remove the demands of multimedia and interactivity as well as the demands of an advertising nature, in that, other than the possibility of downloading multimedia content relating, for example, to a determined item, to a mobile terminal (according to a one to one relationship), it would be possible to use different mobile units to which to convey the the same message and/or multimedia content (according to a relationship of the one to many kind).

The aim of the present invention is, thus, to produce a system for transmitting and managing multimedia content in interactive mode, which permits the multimedia content to be associated with an advertisement, attached in a suitable installation or affixed to the interior or exterior of a means of transport, and to measure the audience.

Another aim of the present invention is to produce a system for transmitting and managing multimedia content in interactive mode, which will permit the user to see on his/her own mobile terminal (for example, his/her own cellular telephone), information content which is additional to the advertisement.

A further aim of the present invention is to produce a system for transmitting and managing multimedia content in interactive mode, which will permit the advertiser client, who is carrying out an outdoor advertising campaign, to use poster installations in order to convey multimedia content in wireless mode to users who have a mobile terminal (such as a cellular telephone).

Not the last aim of the present invention is that of producing a system for transmitting and managing multimedia content in interactive mode, which will permit the audience of an advertising campaign to be measured by means of analysing and counting the wireless connections carried out and the number of interactions activated by the user with the advertising company.

These and other aims are reached in a system for transmitting and managing multimedia content in interactive mode according to Claim 1 which is hereto attached, and which should be referred to for reasons of brevity.

Advantageously, the present invention aims to introduce interactivity into outdoor advertising and, thus, relates to creating a system, which comprises different advertising installations, each of which is dedicated to housing an advertisement and distributing multimedia content.

Such advertising installations inform the audience of the wireless function and contain a transmitter for sending the multimedia file, which is housed in the memory of the individual transmitter, to the user. The file to be sent is associated with the subject of the advertisement on display and varies according to the latter.

In particular, the present invention enables the user to see additional information integrated with the advertising poster on his/her cellular telephone. Cellular telephones have become interactive instruments, which make it easy to acquire, manage and above all store content and information.

In addition, the communications market is transforming rapidly, and advertisers are always looking for more ways to set up direct and measurable relationships with potential customers. The present invention, thanks to interactivity with the user, who can acquire additional information about the message sent, thus permits outdoor advertising to increase its efficiency and to be measured in timely fashion, thanks to wireless technology, by means of the users' mobile terminals, such as cellular telephones.

The system according to the present invention also comprises the software, hardware and electronic components which are necessary for managing the advertising installations, for distributing the files and the posters and for measuring the audience, in terms of both net contacts and redemption.

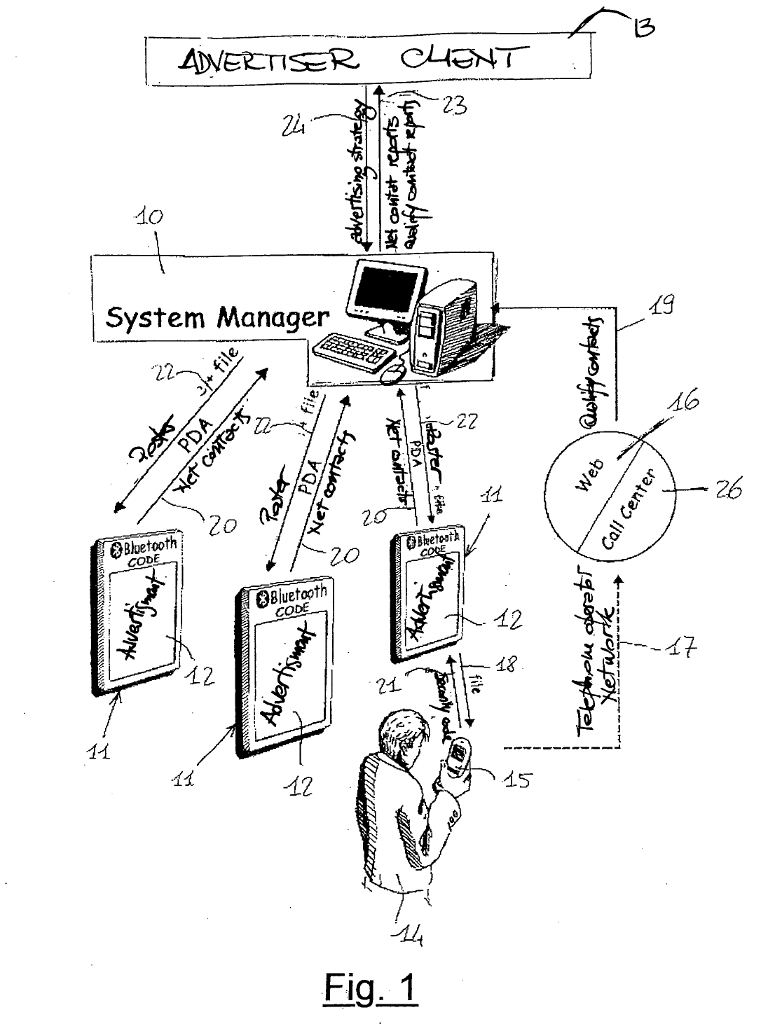

Further characteristics and advantages of the present invention will become more evident in the description which follows, which relates to a preferred but non-limiting form of embodiment, and in the attached drawing (FIG. 1), which shows an outline block diagram of the system for transmitting and managing multimedia content in interactive mode, according to the present invention,

With reference to the above-mentioned drawing, the management and transmission system, according to the present invention, sends multimedia content 22, of the advertising kind, to a series of advertising installations 11, which include respective advertising sheets or posters, containing the advertisement 12 of the advertiser client 13, and inherent files 18 containing information which is integrated with the advertising poster.

Transmission of the multimedia content 22 is preferably carried out using the content transfer service offered by the OBEX protocol, which relies on a wireless data connection such as Bluetooth (the technology on which the description of the form of embodiment which is the subject of the present invention is based), even though it is also possible to use other transmitting standards, such as for example DVB-H, WI-FI, etc.

In addition, the relationship between the advertisement 12 which is affixed in the advertising installation 11 and the multimedia content 22 also holds valid when the advertising poster is attached to the exterior or the interior of a means of transport (dynamic advertising), in particular a public means of transport).

Finally, the advertising poster may be made of paper, but it may also be made of vinyl, PVC, or other plastic material and/or any other type of material whatsoever, and may even be replaced by a screen (LCD, plasma, polymer, etc), on which the image of the advertisement 12 is no longer static, as on a paper background, but moving, like the image on a television screen.

Supposing, as has been stated, as an example of a non-limiting preferred form of embodiment, that a Bluetooth data connection is used, the receivers of the content or users 14 must have a cellular telephone or other mobile terminal 15 which must have such a Bluetooth interface and must be equipped with OBEX push server functions (as defined in the Bluetooth Object Push Profile version 1.1).

The receivers or users 14 must also have explicity activated Bluetooth connectivity on their own terminal 15 and made it visible in public mode. Whenever these conditions are not met, the mobile terminal 15 will not be recognised by the installation and no transfer will be able to take place.

The content is sent using the Object Push functions defined by the standard, while the mode in which the users 14 of the mobile terminals 15 are advised of the request to send and the storage and visualisation mechanisms adopted (like the kind of information which is supported) depends on the individual mobile terminal 15.

The message file 18 may contain a reference to a web site 16 and/or to a call centre 26, with a personalised number of the network 17 of an eventual telephone operator/company, where the user 14 may find further information pertaining to the product and/or service which is advertised.

The manager of the installation can, in turn, take advantage of opportune procedures relating to statistics, which are aimed at measuring the efficiency of the advertising campaign, and which are based on data sent by the multimedia files 18 to the individual mobile terminals 15 and the information (qualified contacts 19 and net contacts 20) which is collected after a subsequent contact with the address indicated.

The system for transmitting and managing multimedia contacts in interactive mode, according to the present invention, comprises suitable central managing equipment or a server 10, which is made up of at least one processor, a mass storage device and one or more network interfaces which conform to the standard which is being used (such as, for example, the Bluetooth standard).

The storage device saves the advertising content and registers all the operations which are carried out, while the processor follows a continuous “inquiry” procedure concerning the surrounding area in order to find Bluetooth devices which offer the transfer service of content as defined by the OBEX protocol and, as each new device is identified, the processor suggests sending the advertising content.

The processor can be configured in order to request, in the initial phases of activating a connection with a mobile terminal 15, the use of a numerical security code 21, which is aimed at guaranteeing the identity of the parties involved (Bluetooth “pairing” procedure).

Such a code may be fixed and made known in some way to the user 14 or it may be generated in casual fashion by the processor, whenever there is a new connection.

In this case, the processor can be endowed with a display unit, which shows the pre-selected code for the time necessary for the connection operation to be completed.

The occurrence of the sending operation is registered by the storage device, in order to calculate the amount of audience reached, as well as to avoid re-sending undesirable content to a determined end user 14.

In the case that there is more than one advertising installation 11 in a restricted area (or rather within the range covered by the Bluetooth standard), the equipment which is present inside them forms a determined and specific network and by means of such a network the units can maintain a database which is shared and which relates to the content sending operations to each identified mobile unit 15, with the aim of avoiding the sending of duplicates.

Finally, by means of opportune procedures, the manager of the installation can update the advertising content which is stored in each unit and can also collect the statistics which relate to the operations which have been carried out.

The functioning of the system for transmitting and managing multimedia content in interactive mode, according to the present invention, is substantially as follows.

In a first functioning mode (pull mode), the user 14 has previously downloaded a determined application to his/her own terminal 15, which enables communication with the advertising installation and, in particular, with the management equipment 10 of the multimedia content 22.

In an additional functioning mode (push mode), the user 14, equipped with a Bluetooth mobile terminal 15 and interested in acquiring additional material, who passes near the advertising installation, is detected by the system, which suggests making a connection. The system therefore activates the “pairing” procedure, which can take place in anonymous form or protected form.

The anonymous form provides for the user 14 to simply accept the connection attempt from the system in order to download the additional file 18 to his/her own mobile terminal 15, while the protected form provides for the user to insert a fixed or variable security code 21, which appears in the advertising installation, before being able to proceed to downloading the file 18 to his/her own terminal 15. The application can be downloadable, as described above, as it can exist as an additional component to an application which is already installed on the mobile terminal 15; for example, if the mobile terminal is supplied with a browser such as Microsoft's Internet Explorer, the application can become a component of the browser which permits the latter to surf in real space as well.

Once the “pairing” procedure has been carried out, the installation sends the file 18 with the multimedia content in wireless mode and the owner of the mobile terminal 15 needs only to accept the file 18 which has been sent.

The advertiser client 13 can thus measure the advertising campaign's audience, thanks to the report 23 which is compiled by the system relating to the overall number of generated net contacts 20, which are equal to the number of wireless connections which have been made.

The results of the report can be cross checked with the results which relate to the audience of the means, in order to obtain an evaluation which relates to the impact of the advertising campaign on the public and to carry out the planning of new advertisements 24.

The redemption of the campaign is quantified in the report 23 which is compiled by the system relating to the qualified contacts 19 generated by the audience, who have interacted directly with the advertiser client 13, using their own mobile terminal 15 to connect to the dedicated web site 16 or to the call centre 26, with the dedicated telephone number of the network 17.

The distribution of the multimedia content 22 by the management server 10 to the various advertising installations 11 can take place in different ways, according to necessity.

In particular, as the advertising installations 11 may be distributed over an extensive area, a PDA can be used in order to transfer the files from the central database to the individual advertising installations 11, or, as an alternative, a GSM unit can be installed in each individual advertising installation 11.

Apart from GSM connections, GPRS and UMTS connections may also be used and, furthermore, an Ethernet network can also be used, if there is one available. In such a way, by introducing interactivity into outdoor advertising, it is possible to create a system which comprises different advertising installations 11, each of which is dedicated to housing a determined advertisement 12 and to displaying additional multimedia content, by means of a transmitter, which sends the multimedia files 18 which are stored in the memory of each individual transmitter to the user 14, in wireless mode.

The multimedia file 18 which is sent to the user 14 is associated with the subject of the advertisement on display and varies according to the specific advertisement 12 which is adopted.

The present invention permits the user 14 to view on his/her own mobile terminal 15, which is usually a cellular telephone, the additional information content which pertains to the advertisement, in such a way as to associate with the advertisement on display in the appropriate installation 11 direct multimedia content deriving from the connection of the user 14, with the aim of measuring the relative audience.

The advertiser client 13, who is carrying out an outdoor advertising campaign, can thus use the the outdoor display advertising installations 11 in order to convey the multimedia content, in wireless mode, to the users 14 who have a cellular telephone and can measure the audience by means of analysing the wireless connections which have been carried out and the interactions which have been activated by the user 14 with the advertising company.

The foregoing description renders clear the characteristics of the system for transmitting and managing multimedia content in interactive mode, which is the subject of the present invention, and also makes clear its advantages.

Finally, it is clear that numerous variations may be effected in relation to the system for transmitting and managing at issue, without in any way detracting from the principles of novelty which are inherent to the inventive idea, just as it is clear that, in the practical embodiment of the invention, the materials, forms and dimensions of the parts may be of any kind whatsoever in accordance with demand, and may also be replaced with others which are technically equivalent.

1. System for transmitting and managing multimedia content in interactive mode, comprising at least one advertising installation, to which are sent, from a management equipment unit, which includes at least one processor, at least one mass memory storage device and at least one network interface, conforming with a communication standard in use, respective items of multimedia content relating to at least one advertisement, wherein the system transmits, by at least one transmitting device, in wireless mode, multimedia files, which include additional information content, which varies in relation to the advertisement and which is associated with a determined advertisement, and which are sent to users with at least one mobile terminal, in such a way that an advertiser client can measure the advertising audience in relation to the interactions, the wireless connections, and/or the contacts carried out by the user.

2. Transmitting and managing system according to claim 1, wherein said multimedia content, relating to advertising is transmitted using a wireless data connection of the Bluetooth kind or by other transmitting standards.

3. Transmitting and managing system according to claim 1, wherein said advertising installation includes at least one advertising poster, attachable to the interior or the exterior of at least one transport.

4. Transmitting and managing system according to claim 1, wherein said advertising installation includes at least one advertising poster made of paper or vinyl, PVC or other plastic material and/or at least one screen, in which the advertisement is rendered mobile.

5. Transmitting and managing system according to claim 1, wherein said mobile terminals include at least one Bluetooth interface and are suitable for implementing the functions of the OBEX communication protocol.

6. Transmitting and managing system according to claim 1, characterised wherein said multimedia files comprise references to web sites and/or call centers of advertising companies or clients, with which the user may interact by his/her own mobile terminal.

7. Transmitting and managing system according to claim 1, wherein said multimedia files are sent to the user, after the user transmits at least one security code, fixed and/or variable in casual fashion.

8. Transmitting and managing system according to claim 1, wherein said advertising installations and the connected equipment are inserted inside at least one determined transmission network.

9. Transmitting and managing network according to claim 1, wherein said mobile terminals are programmed in a suitable way for entering into a dialogue with the advertising installations and the management equipment of the multimedia content.

10. Transmitting and managing system according to claim 1, wherein said multimedia content is transmitted by PDA devices or GSM, GPRS, UMTS units which are installed in each advertising installation or by an Ethernet network.

11. (canceled)
